(19) United States
(12) Patent Application Publication
(10) Pub. No.: US 2025/0162210 A1
(43) Pub. Date: May 22, 2025

(54) DOUBLE BELT PRESS APPARATUS INCLUDING GUIDE UNIT

(71) Applicant: DYMCO, LTD., YOKOHAMA (JP)

(72) Inventor: Kazunori AOKI, YOKOHAMA (JP)

(73) Assignee: DYMCO, LTD., YOKOHAMA (JP)

(21) Appl. No.: 18/955,195

(22) Filed: Nov. 21, 2024

(30) Foreign Application Priority Data
Nov. 21, 2023 (JP) 2023-197353

(51) Int. Cl. B29C 43/22; B29C 43/48; B29K 105/00; B30B 11/00

(52) U.S. Cl. CPC B29C 43/228; B29C 43/48; B30B 11/001; B29K 2105/251

(57) ABSTRACT

A double belt press apparatus includes an upper belt unit, a lower belt unit, a pressing unit, and a guide unit. The guide unit includes a first guide member and a second guide member. The first guide member has a first guide surface extending along one side edge of the upper endless belt. The second guide member has a second guide surface extending along the other side edge of the upper endless belt. The first and second guide members are disposed so that the first and second guide surfaces block the gap between the upper endless belt and a lower endless belt from sides closer to the side edges, respectively.

### CROSS-REFERENCE TO RELATED APPLICATION

This application claims priority from Japanese Patent Application No. 2023-197353, filed on Nov. 21, 2023, the entirety of which is hereby fully incorporated by reference herein.

### FIELD

The present disclosure relates to a double belt press apparatus configured to pass a workpiece through a gap set between an upper endless belt and a lower endless belt, thereby press-processing the workpiece between the two endless belts.

### BACKGROUND

The statements in this section merely provide background information related to the present disclosure and may not constitute prior art.

There is known a double belt press apparatus for laminating or bonding together members or manufacturing a formed product from a particulate material by pressing a workpiece between a pair of opposing endless belts.

For example, Japanese Patent No. 5936217 discloses a double belt press apparatus including a pair of opposing upper and lower endless belts and pressing members disposed inside the endless belts at respective positions where the endless belts oppose each other, wherein a workpiece passing between the endless belts is pressed while being heated by the pressing members, thereby performing processing of the workpiece.

In general, when processed by the double belt press apparatus, a workpiece spreads in the width direction of the belts by being pressed and compressed in the up-down direction. In particular, when a plate-like formed product is to be manufactured by processing a particulate workpiece, e.g. resin pellet workpiece, or a powdered workpiece, the widthwise spread does not become uniform, resulting in variation in the widthwise dimension of the formed product, and which may also result in a formed product protruding widthwise from the belts. Accordingly, it is general practice to perform additional work such as partially cutting off the formed product so as to make uniform the widthwise dimension of the formed product. Such additional work may cause not only an increase in the number of work processes but also waste of the material.

### SUMMARY

This section provides a general summary of the disclosure and is not a comprehensive disclosure of its full scope or all of its features.

Accordingly, it is an object of the present invention to provide a double belt press apparatus capable of suppressing variation in the widthwise dimension of processed products.

In one form of the present disclosure, a double belt press apparatus is provided that includes: a first belt unit having a first endless belt and a first belt driving mechanism configured to rotationally drive the first endless belt; a second belt unit having a second endless belt disposed in alignment with the first endless belt in an up-down direction and a second belt driving mechanism configured to rotationally drive the second endless belt, the second endless belt having a width greater than that of the first endless belt; a pressing unit having a first pressing device and a second pressing device, the first pressing device supporting an inner peripheral surface of a first opposing running portion of the first endless belt, the second pressing device supporting an inner peripheral surface of a second opposing running portion of the second endless belt, the first opposing running portion and the second opposing running portion being located facing each other; and a guide unit including a first guide member and a second guide member, the first guide member having a first guide surface extending along one side edge of the first opposing running portion to block at least a part of a gap between the first opposing running portion and the second opposing running portion from a side closer to the one side edge, the second guide member having a second guide surface extending along the other side edge of the first opposing running portion to block at least a part of the gap from a side closer to the other side edge, the first guide member being disposed so that the first guide surface contacts the one side edge in a state where the first guide member contacts an outer peripheral surface of the second opposing running portion, the second guide member being disposed so that the second guide surface contacts the other side edge in a state where the second guide member contacts the outer peripheral surface of the second opposing running portion, wherein when the first and second endless belts are rotationally driven, the first guide surface slides against the one side edge and the second guide surface slides against the other side edge.

In the double belt press apparatus, the first and second guide members are disposed so as to block the gap between the first endless belt and the second endless belt from the sides closer to the side edges, respectively. Therefore, the workpiece is guided by the first and second guide members, thereby making it possible to limit the widthwise spread of the workpiece. Accordingly, the widthwise dimension of the workpiece can be made uniform to the dimension between the first guide member and the second guide member, and it is possible to suppress variation in the widthwise dimension.

The first guide member may be disposed so that the first guide surface is pressed against the one side edge, and the second guide member may be disposed so that the second guide surface is pressed against the other side edge.

Because the first and second guide surfaces are pressed against the side edges, respectively, it is possible to prevent the formation of a gap between either of the first and second guide surfaces and the endless belt having the side edges against which the first and second guide surfaces are pressed.

The first guide surface extends along one side edge of the first opposing running portion, and the second guide surface extends along the other side edge of the first opposing running portion. The first and second guide members may be held movably in a horizontal plane, so that when the first endless belt meanders or moves in the width direction, the first and second guide members move in the horizontal plane, following the first endless belt.

The above-described arrangement makes it possible to prevent the formation of a gap between either of the first and second guide surfaces and the first endless belt even when the first endless belt meanders or moves in the width direction during a processing operation.

In another form, the guide unit may further include: first and second horizontal actuators configured to move the first guide member between a contact position where the first guide surface is pressed against the one side edge and a non-contact position where the first guide surface is out of contact with the one side edge; first and second rotary couplers attached to the first guide member at respective positions apart from each other in a running direction of the first opposing running portion of the first endless belt, the first rotary coupler coupling the first guide member to the first horizontal actuator so that the first guide member is rotatable relative to the first horizontal actuator about an axis perpendicular to the first opposing running portion, the second rotary coupler coupling the first guide member to the second horizontal actuator so that the first guide member is rotatable relative to the second horizontal actuator about an axis perpendicular to the first opposing running portion; third and fourth horizontal actuators configured to move the second guide member between a contact position where the second guide surface is pressed against the other side edge and a non-contact position where the second guide surface is out of contact with the other side edge; and third and fourth rotary couplers attached to the second guide member at respective positions apart from each other in the running direction, the third rotary coupler coupling the second guide member to the third horizontal actuator so that the second guide member is rotatable relative to the third horizontal actuator about an axis perpendicular to the first opposing running portion, the fourth rotary coupler coupling the second guide member to the fourth horizontal actuator so that the second guide member is rotatable relative to the fourth horizontal actuator about an axis perpendicular to the first opposing running portion.

The first pressing device may be disposed displaceably in the width direction of the first endless belt and in a direction of rotation about an axis perpendicular to the first opposing running portion of the first endless belt and held between the first and second guide members so as to move following the first endless belt, together with the first and second guide members.

With the above-described arrangement, it is possible to maintain a state where the first pressing device is positioned relative to the first endless belt at all times and hence possible to continue pressing uniformly a workpiece passing between the first endless belt and the second endless belt.

In another form, the guide unit further includes a horizontally moving mechanism configured to move the first and second guide members between a contact position where the first and second guide surfaces are pressed against the side edges, respectively, and a non-contact position where the first and second guide surfaces are out of contact with the side edges, respectively. The first pressing device is disposed displaceably in the width direction of the first endless belt and in a direction of rotation about an axis perpendicular to the first opposing running portion of the first endless belt and configured to be movable between a pressing position where the first pressing device supports the inner peripheral surface of the first endless belt so that the gap between the first opposing running portion of the first endless belt and the second opposing running portion of the second endless belt has a predetermined size for press-processing and a standby position more away from the second pressing device than the pressing position. When the first and second guide members are in the contact position in a state where the first pressing device is in the standby position, the first pressing device is held between the first and second guide members and thus positioned relative to the first and second guide members, so that the first pressing device moves from the standby position to the pressing position while being guided by the first and second guide members.

The above-described arrangement makes it possible to facilitate positioning of the first pressing device relative to the first endless belt.

In still another form, the first endless belt is an upper endless belt, and the second endless belt is a lower endless belt disposed beneath the upper endless belt. The lower endless belt may have a width greater than that of the upper endless belt, so that the first and second guide members contact the side edges, respectively, of the first opposing running portion of the upper endless belt in a state where the first and second guide members contact the outer peripheral surface of the second opposing running portion of the lower endless belt.

The first belt driving mechanism may be transformable between a tension application configuration where tension is applied to the first endless belt and a tension release configuration where the first endless belt is released from tension, so that the first endless belt is positioned in the width direction by rotationally driving the first endless belt in a state where the first belt driving mechanism is in the tension release configuration and the first and second guide members contact the side edges, respectively, of the first endless belt. This arrangement facilitates positioning of the first endless belt relative to the first and second guide members.

The first belt driving mechanism may include a first roller and a second roller which are disposed at respective positions apart from each other in a horizontal direction to support the inner peripheral surface of the first endless belt. The first belt driving mechanism may be transformed from the tension application configuration to the tension release configuration in response to displacement of at least one of the first and second rollers toward the inner side of the first endless belt. The first and second guide members may be movable in the up-down direction between a first position where the first and second guide members contact the second endless belt and a second position where the first and second guide members are away from the second endless belt toward the first roller and the second roller. The first endless belt may be positioned in the width direction by rotationally driving the first endless belt in a state where the first belt driving mechanism is in the tension release configuration and the first and second guide members are in the second position and in contact with the side edges, respectively, of the first endless belt.

In one form of the present disclosure, a double belt press apparatus is provided that includes: a first belt unit having a first endless belt and a first belt driving mechanism configured to rotationally drive the first endless belt; a second belt unit having a second endless belt disposed in alignment with the first endless belt in an up-down direction, and a second belt driving mechanism configured to rotationally drive the second endless belt; a pressing unit having a first pressing device and a second pressing device, the first pressing device supporting an inner peripheral surface of a first opposing running portion of the first endless belt, the second pressing device supporting an inner peripheral surface of a second opposing running portion of the second endless belt, the first opposing running portion and the second opposing running portion being located facing each other; and a guide unit including a first guide member and a second guide member, the first guide member having a first guide surface extending along one side edge of at least one running portion of the first opposing running portion and the second opposing running portion to block at least a part of a gap between the first opposing running portion and the second opposing running portion from a side closer to the one side edge, the second guide member having a second guide surface extending along the other side edge of the at least one running portion to block at least a part of the gap from a side closer to the other side edge, the first guide member being disposed so that the first guide surface contacts the one side edge, the second guide member being disposed so that the second guide surface contacts the other side edge, so that when the first and second endless belts are rotationally driven, the first guide surface slides against the one side edge and the second guide surface slides against the other side edge; wherein the first belt driving mechanism is configured to transform between a tension application configuration to apply tension to the first endless belt and a tension release configuration to release the first endless belt from tension, so that the first endless belt is positioned in the width direction by rotationally driving the first endless belt in a state where the first belt driving mechanism is in the tension release configuration and the first and second guide members contact the side edges, respectively, of the first endless belt.

Embodiments of a double belt press apparatus including a guide unit according to the present invention will be explained below based on the accompanying drawings.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic side view of a double belt press apparatus including a guide unit according to an embodiment of the present invention.

FIG. 2 is a schematic plan view of the double belt press apparatus in

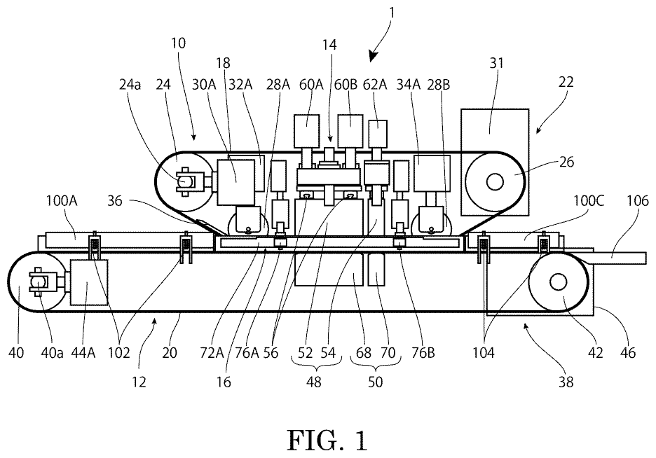

FIG. 1.

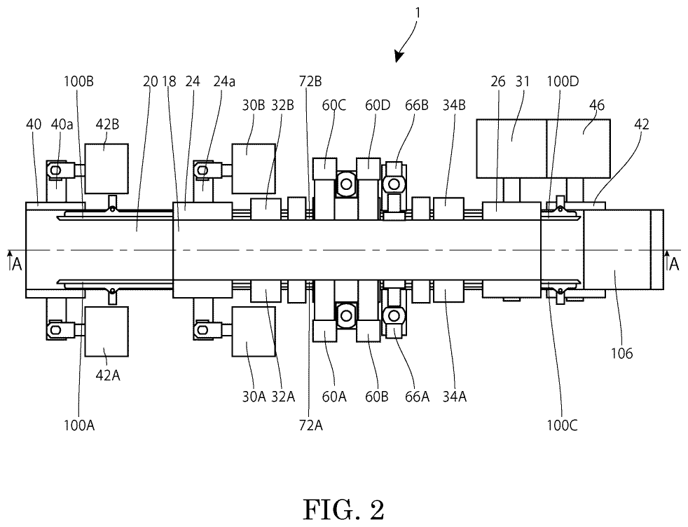

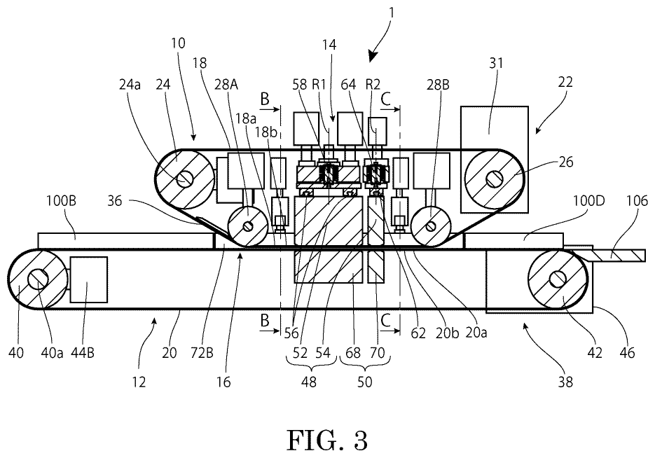

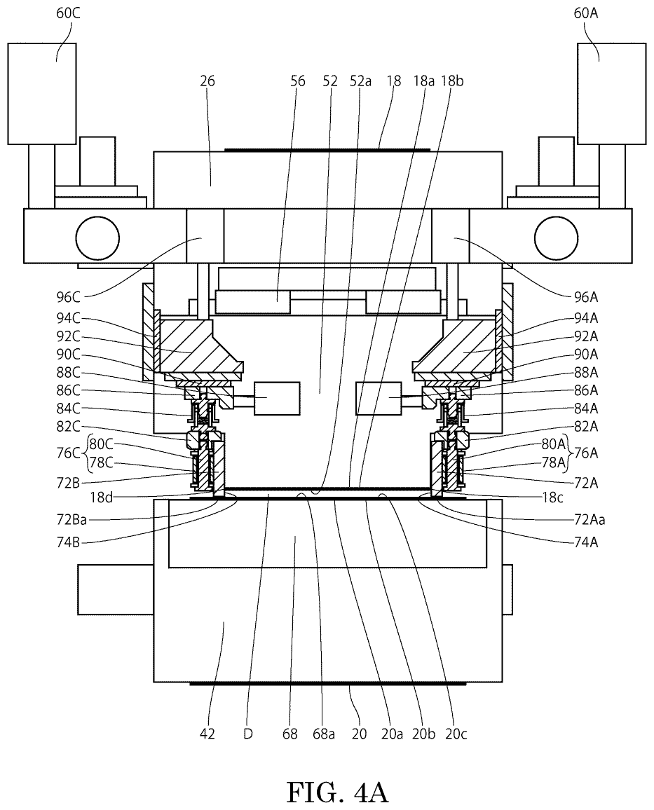

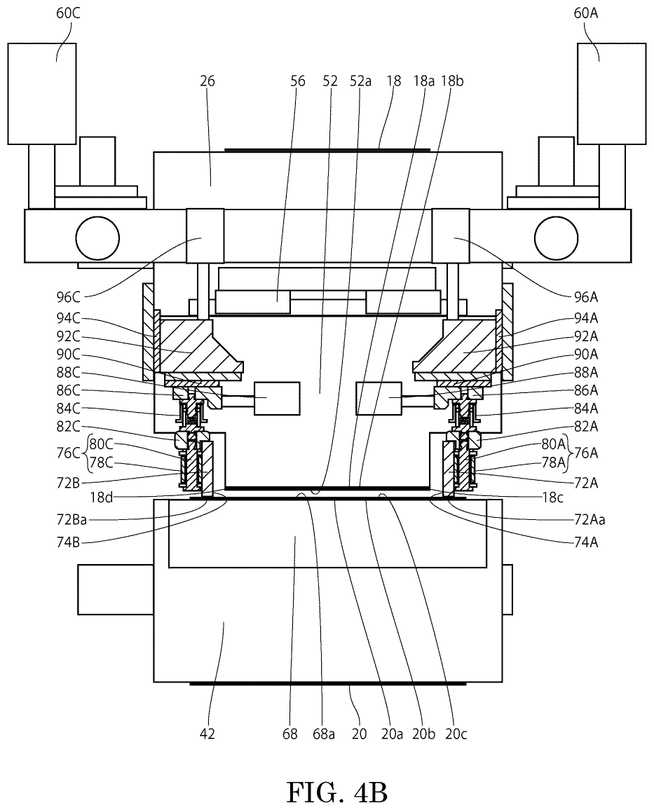

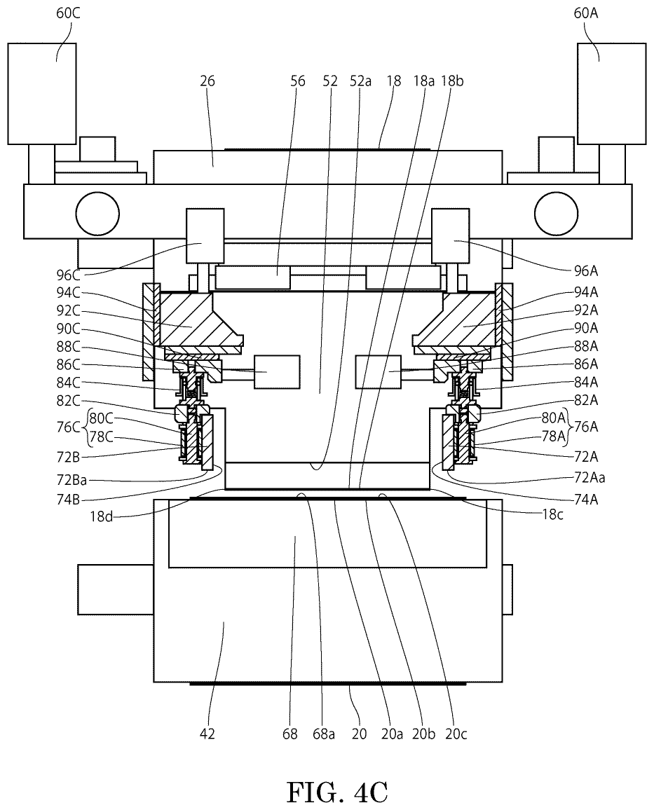

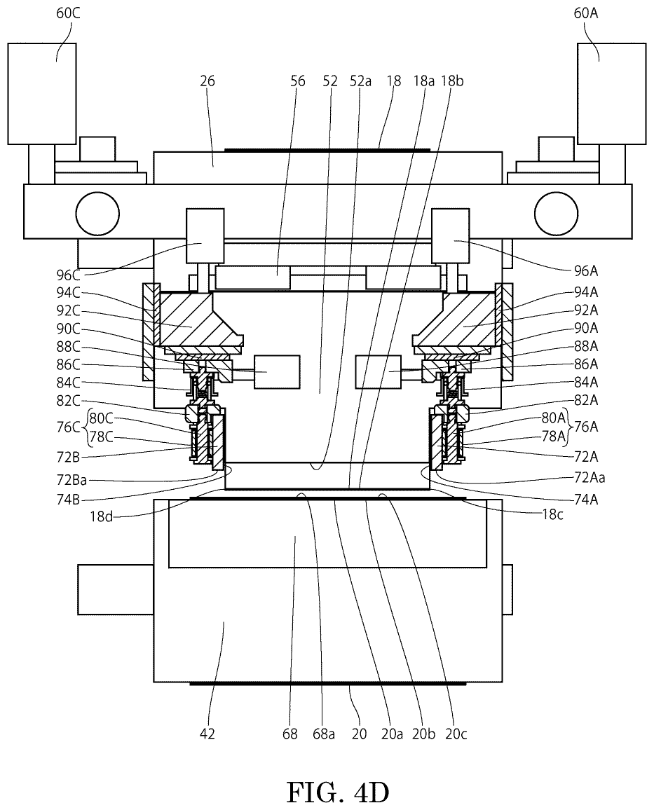

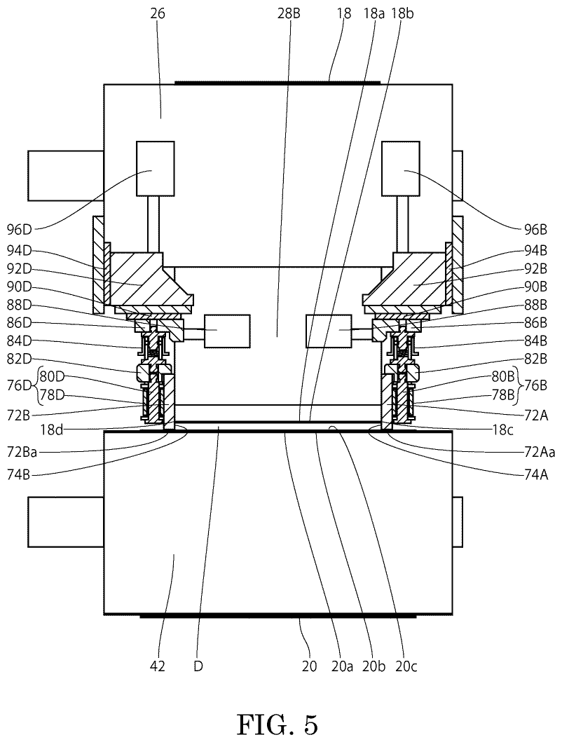

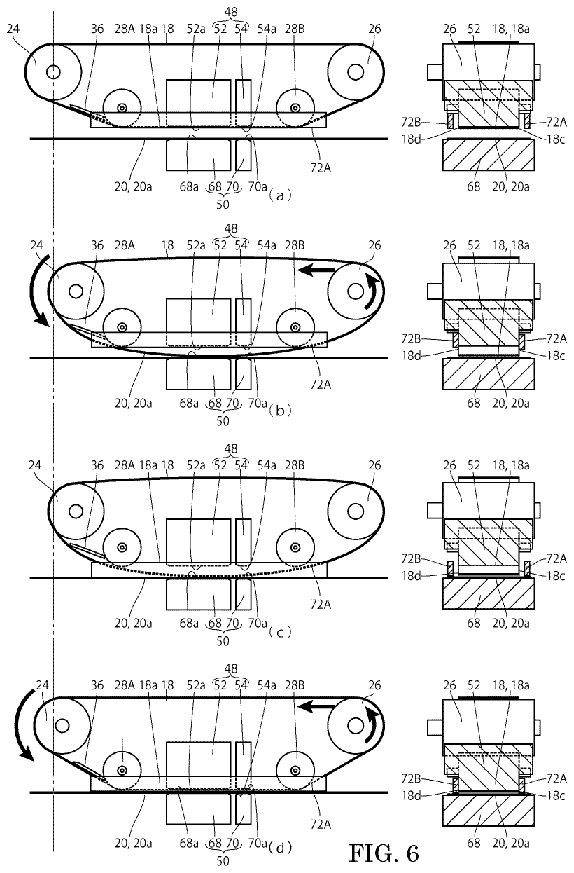

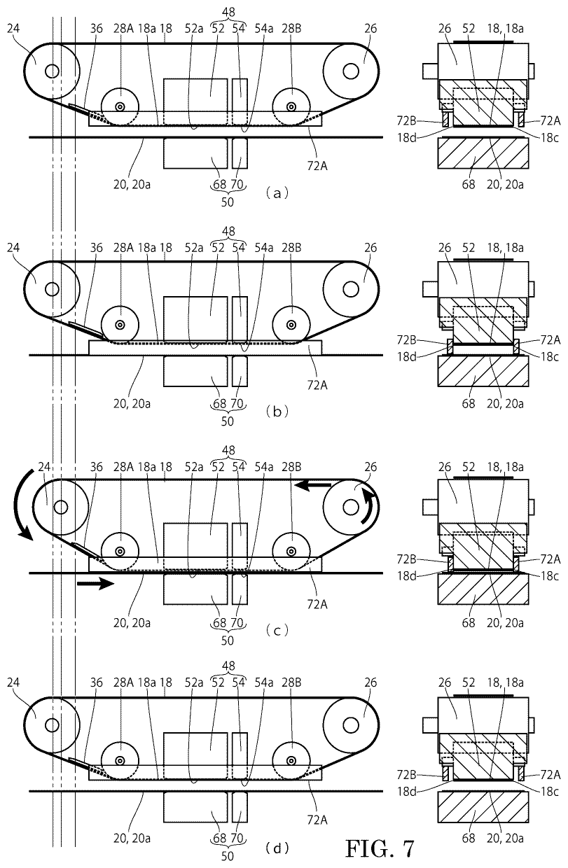

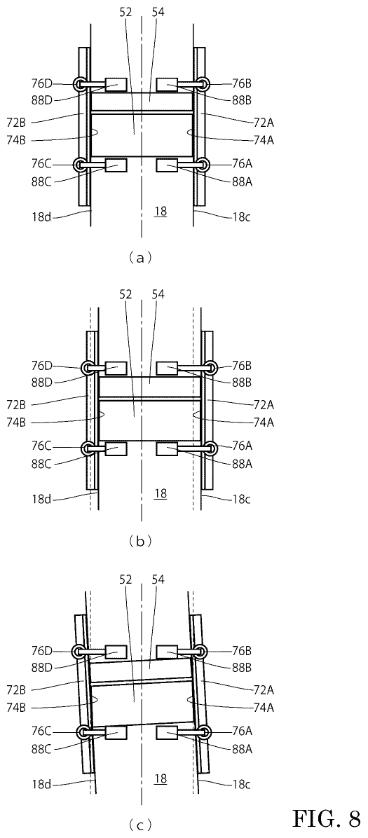

FIG. 3 is a sectional view taken along the line A-A in FIG. 2.

FIG. 4A is a sectional view taken along the line B-B in FIG. 3, showing a state where first and second guide members are in a lower position and in a contact position.

FIG. 4B is a sectional view taken along the line B-B in FIG. 3, showing a state where the first and second guide members are in the lower position and in a non-contact position.

FIG. 4C is a sectional view taken along the line B-B in FIG. 3, showing a state where the first and second guide members are in an upper position and in the non-contact position.

FIG. 4D is a sectional view taken along the line B-B in FIG. 3, showing a state where the first and second guide members are in the upper position and in the contact position.

FIG. 5 is a sectional view taken along the line C-C in FIG. 3.

FIG. 6 is a schematic view showing an operation of positioning an upper endless belt.

FIG. 7 is a schematic view showing a processing operation by the double belt press apparatus.

FIG. 8 is a schematic view showing a following operation of the first and second guide members and an upper pressing device to follow the widthwise movement and meandering of the upper endless belt.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A double belt press apparatus 1 according to an embodiment of the present invention includes, as shown in FIG. 1, an upper belt unit (first belt unit) 10, a lower belt unit (second belt unit) 12, a pressing unit 14, and a guide unit 16. The double belt press apparatus 1 is, as will be described below, configured to press, by the pressing unit 14, a workpiece passing between an upper endless belt (first endless belt) 18 of the upper belt unit 10 and a lower endless belt (second endless belt) 20 of the lower belt unit 12, thereby performing processing of the workpiece.

As shown in FIGS. 1 to 3, the upper belt unit 10 includes an upper belt driving mechanism (first belt driving mechanism) 22 configured to rotationally drive the upper endless belt 18. The upper belt driving mechanism 22 has a driven roller (first roller) 24, a driving roller (second roller) 26, and two auxiliary rollers 28A and 28B. The driven roller 24 is rotatably held relative to a rotating shaft 24a thereof. The rotating shaft 24a has opposite end portions connected to a pair of air cylinders 30A and 30B, respectively. The driven roller 24 is movable in the longitudinal direction (left-right direction as seen in the figures) by the air cylinders 30A and 30B to adjust tension to be applied to the upper endless belt 18. The driving roller 26 is connected to an electric motor 31 so as to be rotationally driven by the electric motor 31. The forward auxiliary roller 28A is held by a pair of air cylinders 32A and 32B so as to be movable in the up-down direction by the air cylinders 32A and 32B. Similarly, the rearward auxiliary roller 28B is held by a pair of air cylinders 34A and 34B so as to be movable in the up-down direction by the air cylinders 34A and 34B. The upper belt unit 10 further includes a support plate 36 disposed forward of the auxiliary roller 28A. The support plate 36 is disposed so as to support the inner peripheral surface of the upper endless belt 18 at a position forward of the auxiliary roller 28A. The support plate 36 is connected to the air cylinders 32A and 32B by a coupling mechanism (not shown) so as to be moved in the up-down direction while tilting by the air cylinders 32A and 32B in a linked relation to the auxiliary roller 28A. In this embodiment, the support plate 36 is formed of a resin material. In the state shown in FIGS. 1 to 3, the driven roller 24, the driving roller 26, and the auxiliary rollers 28A and 28B support the inner peripheral surface of the upper endless belt 18 to apply tension to the upper endless belt 18. The upper endless belt 18 is allowed to rotate counterclockwise as seen in FIGS. 1 and 3 by rotationally driving the driving roller 26 in a state where tension is applied to the upper endless belt 18.

The lower belt unit 12 includes a lower belt driving mechanism (second belt driving mechanism) 38 configured to rotationally drive a lower endless belt (second endless belt) 20 disposed beneath the upper endless belt 18 in alignment therewith. The lower belt driving mechanism 38 has a driven roller 40 and a driving roller 42. The driven roller 40 is rotatably held relative to a rotating shaft 40a thereof. The rotating shaft 40a has opposite end portions connected to a pair of air cylinders 44A and 44B, respectively. The driven roller 40 is longitudinally movable by the air cylinders 44A and 44B to adjust tension to be applied to the lower endless belt 20. The driving roller 42 is connected to an electric motor 46 so as to be rotationally driven by the electric motor 46. The lower endless belt 20 is allowed to rotate clockwise as seen in FIGS. 1 and 3 by rotationally driving the driving roller 42 in a state where tension is applied to the lower endless belt 20 by the air cylinders 44A and 44B. In this embodiment, as shown in FIG. 4A, the lower endless belt 20 has a width greater than that of the upper endless belt 18. The upper endless belt 18 and the lower endless belt 20 in this embodiment are made of stainless steel; however, these stainless-steel endless belts may be provided on their surfaces with various resin films in conformity with the contents of the processing process and the constituent material of the workpiece. The upper and lower endless belts 18 and 20 may also be rubber belts.

The pressing unit 14 includes, as shown in FIG. 3, an upper pressing device (first pressing device) 48 and a lower pressing device (second pressing device) 50 which are disposed in alignment with each other in the up-down direction. The upper pressing device 48 is disposed so as to support, from above, an inner peripheral surface 18b of a lower running portion (first opposing running portion) 18a of the upper endless belt 18 at a position where the lower running portion 18a and an upper running portion (second opposing running portion) 20a of the lower endless belt 20 are located facing each other across a gap D (FIG. 4A). The lower pressing device 50 is disposed so as to support, from below, an inner peripheral surface 20b of the upper running portion 20a of the lower endless belt 20. The upper pressing device 48 includes a forward heating-pressing member 52 and a rearward cooling-pressing member 54. The heating-pressing member 52 is installed so as to be displaceable in the width direction of the upper endless belt 18 by sliders 56. The heating-pressing member 52 is also displaceable by a rotating shaft 58 in the direction of rotation about an axis R1 perpendicular to the lower running portion 18a of the upper endless belt 18. In addition, the heating-pressing member 52 is configured to be movable in the up-down direction by four air cylinders 60A, 60B, 60C and 60D (FIG. 2). Similarly, the cooling-pressing member 54 is installed so as be displaceable in the width direction of the upper endless belt 18 by a slider 62. The cooling-pressing member 54 is also displaceable by a rotating shaft 64 in the direction of rotation about an axis R2 perpendicular to the lower running portion 18a of the upper endless belt 18. In addition, the cooling-pressing member 54 is movable in the up-down direction by two air cylinders 66A and 66B (FIG. 2). The lower pressing device 50 includes a forward heating-pressing member 68 and a rearward cooling-pressing member 70. The heating-pressing member 52 of the upper pressing device 48 and the heating-pressing member 68 of the lower pressing device 50 are disposed in alignment with each other so as to oppose each other in the up-down direction. In addition, the cooling-pressing member 54 of the upper pressing device 48 and the cooling-pressing member 70 of the lower pressing device 50 are disposed in alignment with each other so as to oppose each other in the up-down direction.

As shown in FIG. 4A, the width of a lower surface 52a of the heating-pressing member 52 of the upper pressing device 48 is substantially the same as the width of the upper endless belt 18. Similarly, a lower surface 54a of the cooling-pressing member 54 has a width substantially the same as the width of the upper endless belt 18. Consequently, the heating-pressing member 52 and cooling-pressing member 54 of the upper pressing device 48 can support the entire widthwise area of the upper endless belt 18 and hence can uniformly press the workpiece. On the other hand, the width of an upper surface 68a of the heating-pressing member 68 of the lower pressing device 50 is even wider than the width of the lower endless belt 20, which is wider than the upper endless belt 18. Similarly, the width of an upper surface 70a of the cooling-pressing member 70 is even wider than the width of the lower endless belt 20. Consequently, the heating-pressing member 68 and cooling-pressing member 70 of the lower pressing device 50 can continuously support the lower endless belt 20 by the entire widthwise area thereof even if the lower endless belt 20 deviates in the width direction.

In this embodiment, the heating-pressing member 52 and the heating-pressing member 68 each have a built-in electric heater (not shown) as a heating device, and the cooling-pressing member 54 and the cooling-pressing member 70 each have a built-in coolant pipe (not shown) as a cooling device. However, any other desired heating and cooling devices may also be used. In addition, the structures of the upper pressing device 48 and the lower pressing device 50 may be modified according to the contents of the processing process. For example, the upper pressing device 48 and the lower pressing device 50 may each have a structure including only a heating-pressing member and not including a cooling-pressing member. The heating-pressing member and the cooling-pressing member may be constructed as a one-piece member. It is also possible to use pressing members having no heating or cooling function. In addition, the upper and lower pressing devices 48 and 50 may each include a plurality of heating-pressing members or a plurality of cooling-pressing members. Although the pressing members 52, 54, 68 and 70 in this embodiment comprise block-shaped members, respectively, the pressing members may comprise roller-shaped members, respectively, which rotate together with the upper endless belt 18 and the lower endless belt 20. In this case also, the number and arrangement of rollers constituting the heating-pressing member and the cooling-pressing member may be changed as desired.

The guide unit 16 includes a first guide member 72A and a second guide member 72B which are disposed at the lateral sides, respectively, of the upper pressing device 48. The first guide member 72A is disposed along one side edge 18c of the lower running portion 18a of the upper endless belt 18. The second guide member 72B is disposed along the other side edge 18d of the lower running portion 18a of the upper endless belt 18. The first guide member 72A and the second guide member 72B extend longitudinally over the entire length of the lower running portion 18a of the upper endless belt 18 between the auxiliary roller 28A and the auxiliary roller 28B. In this embodiment, the first guide member 72A and the second guide member 72B are formed of a resin material.

As shown in FIGS. 4A and 5, the first guide member 72A has a first guide surface 74A extending along the one side edge 18c of the upper endless belt 18. Similarly, the second guide member 72B has a second guide surface 74B extending along the other side edge 18d of the upper endless belt 18. The first guide surface 74A and the second guide surface 74B vertically extend from the upper running portion 20a to further above the lower running portion 18a. The first guide surface 74A blocks the entire gap D between the lower running portion 18a and the upper running portion 20a from a side closer to the side edge 18c. Similarly, the second guide surface 74B blocks the entire gap D between the lower running portion 18a and the upper running portion 20a from a side closer to the side edge 18d. It should be noted that the first and second guide surfaces 74A and 74B may be configured to block only a part of the gap D from the sides closer to the side edges 18c and 18d, respectively. That is, the arrangement may be, for example, such that the first and second guide surfaces 74A and 74B block the gap D only a part thereof between the auxiliary roller 28A and the cooling-pressing member 54.

The guide unit 16 further includes a first rotary coupler 76A (FIG. 4A) and a second rotary coupler 76B (FIG. 5) which are attached to the first guide member 72A at respective positions apart from each other in the running direction of the lower running portion 18a of the upper endless belt 18. The first rotary coupler 76A comprises a retaining member 78A secured to the first guide member 72A and a shaft member 80A rotatably retained by the retaining member 78A. The first rotary coupler 76A is coupled to an air cylinder (first horizontal actuator) 88A for the horizontal direction through a coupling block 82A, a one-touch joint 84A, and a coupling block 86A. The coupling block 86A is attached to a coupling block 92A through a slider 90A for the horizontal direction. The first rotary coupler 76A couples the first guide member 72A to the air cylinder 88A so that the first guide member 72A is rotatable relative to the air cylinder 88A about an axis perpendicular to the lower running portion 18a. Similarly, the second rotary coupler 76B comprises a retaining member 78B secured to the first guide member 72A and a shaft member 80B rotatably retained by the retaining member 78B. The second rotary coupler 76B is coupled to an air cylinder (second horizontal actuator) 88B for the horizontal direction through a coupling block 82B, a one-touch joint 84B, and a coupling block 86B. The coupling block 86B is attached to a coupling block 92B through a slider 90B for the horizontal direction. The second rotary coupler 76B couples the first guide member 72A to the air cylinder 88B so that the first guide member 72A is rotatable relative to the air cylinder 88B about an axis perpendicular to the lower running portion 18a. The foregoing arrangement forms a horizontal moving mechanism for moving the first guide member 72A in the horizontal direction. The coupling block 92A is installed so as to be movable in the up-down direction by a slider 94A for the vertical direction, and the coupling block 92A is equipped with an air cylinder 96A for the vertical direction. Similarly, the coupling block 92B is installed so as to be movable in the up-down direction by a slider 94B for the vertical direction, and the coupling block 92B is equipped with an air cylinder 96B for the vertical direction. The foregoing arrangement forms a vertical moving mechanism for moving the first guide member 72A in the vertical direction.

The guide unit 16 further includes a third rotary coupler 76C (FIG. 4C) and a fourth rotary coupler 76D (FIG. 5) which are attached to the second guide member 72B at respective positions apart from each other in the running direction of the lower running portion 18a of the upper endless belt 18. The third rotary coupler 76C has a retaining member 78C secured to the second guide member 72B and a shaft member 80C rotatably retained by the retaining member 78C. The third rotary coupler 76C is coupled to an air cylinder (third horizontal actuator) 88C for the horizontal direction through a coupling block 82C, a one-touch joint 84C, and a coupling block 86C. The coupling block 86C is attached to a coupling block 92C through a slider 90C for the horizontal direction. The third rotary coupler 76C couples the second guide member 72B to the air cylinder 88C so that the second guide member 72B is rotatable relative to the air cylinder 88C about an axis perpendicular to the lower running portion 18a. Similarly, the fourth rotary coupler 76D comprises a retaining member 78D secured to the second guide member 72B, and a shaft member 80D rotatably retained by the retaining member 78D. The fourth rotary coupler 76D is coupled to an air cylinder (fourth horizontal actuator) 88D for the horizontal direction through a coupling block 82D, a one-touch joint 84D, and a coupling block 86D. The coupling block 86D is attached to a coupling block 92D through a slider 90D for the horizontal direction. The fourth rotary coupler 76D couples the second guide member 72B to the air cylinder 88D so that the second guide member 72B is rotatable relative to the air cylinder 88D about an axis perpendicular to the lower running portion 18a. The foregoing arrangement forms a horizontal moving mechanism for moving the second guide member 72B in the horizontal direction. The coupling block 92C is installed so as to be movable in the up-down direction by a slider 94C for the vertical direction, and the coupling block 92C is equipped with an air cylinder 96C for the vertical direction. Similarly, the coupling block 92D is installed so as to be movable in the up-down direction by a slider 94D for the vertical direction, and the coupling block 92D is equipped with an air cylinder 96D for the vertical direction. The foregoing arrangement forms a vertical moving mechanism for moving the second guide member 72B in the vertical direction.

The first guide member 72A and the second guide member 72B are configured to be movable in both the horizontal and vertical directions as shown in FIGS. 4A to 4D by the air cylinders 88A to 88D and 96A to 96D, which are secured to a machine frame (not shown).

The first guide member 72A is movable by the air cylinders 88A and 88B for the horizontal direction between a contact position (FIGS. 4A and 4D) where the first guide surface 74A is pressed against the side edge 18c of the upper endless belt 18 and a non-contact position (FIGS. 4B and 4C) where the first guide surface 74A is out of contact with the side edge 18c. Similarly, the second guide member 72B is movable by the air cylinders 88C and 88D for the horizontal direction between a contact position (FIGS. 4A and 4D) where the second guide surface 74B is pressed against the side edge 18d of the upper endless belt 18 and a non-contact position (FIGS. 4B and 4C) where the second guide surface 74B is out of contact with the side edge 18d. In addition, the first guide member 72A is movable by the air cylinders 96A and 96B for the vertical direction between a lower position (first position; FIGS. 4A and 4B) where a lower surface 72Aa of the first guide member 72A is in contact with an outer peripheral surface 20c of the lower endless belt 20 and an upper position (second position; FIGS. 4C and 4D) where the lower surface 72Aa of the first guide member 72A is upwardly away from the outer peripheral surface 20c of the lower endless belt 20. Similarly, the second guide member 72B is movable by the air cylinders 96C and 96D for the vertical direction between a lower position (first position; FIGS. 4A and 4B) where a lower surface 72Ba of the second guide member 72B is in contact with the outer peripheral surface 20c of the lower endless belt 20 and an upper position (second position; FIGS. 4C and 4D) where the lower surface 72Ba of the second guide member 72B is upwardly away from the outer peripheral surface 20c of the lower endless belt 20. In this embodiment, the first guide member 72A and the second guide member 72B are configured to move between the four positions shown in FIGS. 4A to 4D in a linked manner.

As shown in FIGS. 1 to 3, the double belt press apparatus 1 further includes a first fixed guide member 100A and a second fixed guide member 100B which are disposed forward of the first guide member 72A and the second guide member 72B, respectively. The first fixed guide member 100A and the second fixed guide member 100B are fixedly disposed at respective positions where the first and second fixed guide members 100A and 100B align with the first guide member 72A and the second guide member 72B, respectively, when the first and second guide members 72A and 72B are in the lower position and in the contact position (FIG. 4A). In addition, the first fixed guide member 100A and the second fixed guide member 100B are each pressed against the outer peripheral surface 20c of the lower endless belt 20 by two springs 102 (FIG. 1). The double belt press apparatus 1 further includes a third fixed guide member 100C and a fourth fixed guide member 100D which are disposed rearward of the first guide member 72A and the second guide member 72B, respectively. The third fixed guide member 100C and the fourth fixed guide member 100D are fixedly disposed at respective positions where the third and fourth fixed guide members 100C and 100D align with the first guide member 72A and the second guide member 72B, respectively, when the first and second guide members 72A and 72B are in the lower position and in the contact position (FIG. 4A). In addition, the third fixed guide member 100C and the fourth fixed guide member 100D are each pressed against the outer peripheral surface 20c of the lower endless belt 20 by two springs 104 (FIG. 1).

In this embodiment, when performing processing of a workpiece, the double belt press apparatus 1 assumes a configuration shown in FIGS. 1 to 3, 4A and 5. The upper pressing device 48 is adjusted in position in the height direction by the four air cylinders 60A, 60B, 60C and 60D so that the gap D between the lower running portion 18a of the upper endless belt 18 and the upper running portion 20a of the lower endless belt 20 has a predetermined size required for press-processing. The two auxiliary rollers 28A and 28B are positioned by the pair of air cylinders 32A and 32B and the pair of air cylinders 34A and 34B so that the respective lower ends of the auxiliary rollers 28A and 28B coincide with the lower surface 52a of the heating-pressing member 52 and the lower surface 54a of the cooling-pressing member 54, respectively, of the upper pressing device 48. At this time, as the forward auxiliary roller 28A moves, the support plate 36 also moves to a position corresponding to the position of the auxiliary roller 28A. The driven roller 24 is pressed against the upper endless belt 18 by the pair of air cylinders 30A and 30B so as to apply an appropriate tension to the upper endless belt 18. The first guide member 72A and the second guide member 72B are in the lower position where the lower surfaces 72Aa and 72Ba thereof are in contact with the outer peripheral surface 20c of the lower endless belt 20, and the first and second guide members 72A and 72B are in the contact position where the first guide surface 74A and the second guide surface 74B are in contact with the side edges 18c and 18d, respectively, of the upper endless belt 18. It should be noted that the auxiliary rollers 28A and 28B and the support plate 36 are provided to guide the upper endless belt 18 substantially in parallel to the lower surfaces 52a and 54a of the heating-pressing member 52 and cooling-pressing member 54 of the upper pressing device 48; however, the auxiliary rollers 28A and 28B and the support plate 36 are not always necessary. The auxiliary rollers 28A and 28B and the support plate 36 may be eliminated, for example, by arranging such that the lower surface 52a of the heating-pressing member 52 and the lower surface 54a of the cooling-pressing member 54 are at substantially the same height as the lower ends of the driven roller 24 and the driving roller 26.

With the double belt press apparatus 1 set in the configuration shown in FIGS. 1 to 3, 4A and 5 as described above, the upper endless belt 18 is driven counterclockwise as seen in FIG. 1, while the lower endless belt 20 is driven clockwise, and a workpiece to be processed is placed on the lower endless belt 20, thereby performing processing of the workpiece. At this time, the first guide member 72A and the second guide member 72B are stationary in the running direction of the lower running portion 18a of the upper endless belt 18 and the upper running portion 20a of the lower endless belt 20, and the upper endless belt 18 and the lower endless belt 20, which are rotating, slide in contact with the first guide member 72A and the second guide member 72B.

Here, an example is provided to explain the production of a plate-like resin formed product by processing particulate resin pellets. When the resin pellets are supplied onto an area of the lower endless belt 20 between the first fixed guide member 100A and the second fixed guide member 100B, the resin pellets are conveyed by the lower endless belt 20. At this time, it is desirable that the resin pellets should be supplied with uniform thickness over the area between the first fixed guide member 100A and the second fixed guide member 100B. The resin pellets conveyed by the lower endless belt 20 pass through the gap D between the upper endless belt 18 and the lower endless belt 20 while being sandwiched between the upper and lower endless belts 18 and 20 in the vicinity of the forward auxiliary roller 28A. When the resin pellets reach the area between the heating-pressing member 52 of the upper pressing device 48 and the heating-pressing member 68 of the lower pressing device 50, the resin pellets are vertically pressed between the heating-pressing member 52 and the heating-pressing member 68 while being heated. While passing between the heating-pressing members 52 and 68, the resin pellets are softened or melted and thus formed into an integral plate-like member. Thereafter, the formed member is cooled and cured when passing between the cooling-pressing member 54 of the upper pressing device 48 and the cooling-pressing member 70 of the lower pressing device 50. The integrated and cured plate-like resin formed product passes between the upper endless belt 18 and the lower endless belt 20 and is further conveyed by the lower endless belt 20 to reach a product tray 106.

When pressed between the upper endless belt 18 and the lower endless belt 20, the resin pellets are forced to spread in the width direction of the upper endless belt 18. In particular, when the resin pellets pass between the upper pressing device 48 and the lower pressing device 50 while being heated, the spread in the width direction of the upper endless belt 18 is likely to increase. In the double belt press apparatus 1 according to this embodiment, however, the first guide member 72A and the second guide member 72B are disposed along the side edges 18c and 18d, respectively, of the upper endless belt 18 so as to block the gap D from both sides. Therefore, the spread of the resin pellet workpiece is limited by the first guide member 72A and the second guide member 72B. Accordingly, the resin formed product cannot spread in excess of the width of the upper endless belt 18. In addition, because the resin formed product is formed while the side surfaces thereof are being guided along the first guide surface 74A and the second guide surface 74B, respectively, it is possible to manufacture a resin formed product having a uniform width. Although in the foregoing example the resin pellets are press-processed into a plate-like resin formed product, the double belt press apparatus 1 according to this embodiment is also capable of performing other processing processes such as those generally carried out by the conventional double belt press apparatus. For example, it is also possible to perform laminating of a plurality of sheet-shaped materials or rolling of a plate-shaped member. In such other processing processes, it is also possible to make uniform the widthwise dimension of the processed product by limiting the widthwise spread of the workpiece while guiding the workpiece by the first guide member 72A and the second guide member 72B.

When performing the above-described processing operation using the first guide member 72A and the second guide member 72B, it is desirable that the first guide surface 74A and the second guide surface 74B should be in contact with the side edges 18c and 18d, respectively, of the upper endless belt 18 without a gap therebetween. In the double belt press apparatus 1 according to this embodiment, the air cylinder 88A and the air cylinder 88B are configured to apply force to the first guide member 72A in the direction toward the upper endless belt 18 so that the first guide surface 74A is pressed against and in contact with the side edge 18c. Similarly, the air cylinder 88C and the air cylinder 88D are configured to apply force to the second guide member 72B in the direction toward the upper endless belt 18 so that the second guide surface 74B is pressed against and in contact with the side edge 18d. Because the first guide surface 74A and the second guide surface 74B are pressed against the side edges 18c and 18d, respectively, of the upper endless belt 18, a gap is unlikely to be formed between the first guide surface 74A and the side edge 18c and between the second guide surface 74B and the side edge 18d, and the gap D between the lower running portion 18a and the upper running portion 20a can be appropriately closed from both sides.

In a case where the first guide member 72A and the second guide member 72B are pressed against the upper endless belt 18 as described above, the first and second guide members 72A and 72B become worn easily because of sliding against the rotating upper endless belt 18. Therefore, the double belt press apparatus 1 according to this embodiment is configured such that when processing is not performed, the first guide member 72A and the second guide member 72B are each moved to a non-contact position (FIG. 4B) which is away from the upper endless belt 18. When the wear of the first and second guide members 72A and 72B has progressed more than a certain extent, the first and second guide members 72A and 72B may be replaced. In the double belt press apparatus 1 according to this embodiment, the first guide member 72A and the second guide member 72B are attached by the respective pairs of one-touch joints 84A to 84D; therefore, it is easy to replace the first and second guide members 72A and 72B with new guide members.

Furthermore, the double belt press apparatus 1 according to this embodiment is capable of positioning the upper endless belt 18 by making use of the first guide member 72A and the second guide member 72B in order to achieve a state where the first guide surface 74A and the second guide surface 74B appropriately contact the side edges 18c and 18d, respectively. The operation of positioning the upper endless belt 18 is described below with reference to FIG. 6.

When in an inactive state where processing is not performed, the double belt press apparatus 1 according to this embodiment assumes a configuration shown in FIG. 6(a). That is, the heating-pressing member 52 and cooling-pressing member 54 of the upper pressing device 48 are in a standby position where the heating-pressing member 52 and the cooling-pressing member 54 are sufficiently upwardly away from the heating-pressing member 68 and cooling-pressing member 70 of the lower pressing device 50. The first guide member 72A and the second guide member 72B are in an upper position where the first and second guide members 72A and 72B are upwardly away from the lower endless belt 20 toward the driven roller 24 and the driving roller 26. Besides, the first guide member 72A and the second guide member 72B are in a non-contact position where the first and second guide members 72A and 72B are laterally away from the upper endless belt 18 as well as the heating-pressing member 52 and the cooling-pressing member 54. The auxiliary rollers 28A and 28B are in a position where the lower ends of the auxiliary rollers 28A and 28B are at substantially the same height as the lower surfaces 52a and 54a of the heating-pressing member 52 and cooling-pressing member 54 of the upper pressing device 48 when in the standby position. In addition, the driven roller 24 is in a forward position by being urged forward (leftward as seen in the figure) by the air cylinders 30A and 30B so as to apply a certain magnitude of force to the upper endless belt 18. Thus, the upper belt driving mechanism 22 assumes a tension application configuration to apply tension to the upper endless belt 18. In the tension application configuration at this time, however, a relatively small tension is applied to the upper endless belt 18 so that a frictional force acts to such an extent that the upper endless belt 18 will not unnecessarily move in the width direction.

To perform positioning of the upper endless belt 18, the upper belt driving mechanism 22 is transformed from the tension application configuration to the tension release configuration. Specifically, the driven roller 24 is displaced inward of the upper endless belt 18 (i.e. rearward) to assume a rearward position. Consequently, the tension applied to the upper endless belt 18 is released, so that the upper endless belt 18 becomes loose to some extent. It should be noted that the upper belt driving mechanism 22 may be transformed to the tension release configuration by inward (forward) displacement of the driving roller 26. Subsequently or simultaneously with the above, the first guide member 72A and the second guide member 72B are displaced inward in the width direction in the upper position to assume a contact position. In this state, as shown in FIG. 6(b), the driving roller 26 is driven to rotate. The upper endless belt 18 has been released from tension but is sitting on the driven roller 24 and the driving roller 26. Therefore, the upper endless belt 18 rotates in response to the rotation of the driving roller 26. If the upper endless belt 18 deviates from the center position in the width direction of the driven and driving rollers 24 and 26, the upper endless belt 18 is pressed stronger by either of the first and second guide members 72A and 72B toward which the upper endless belt 18 deviates. Accordingly, the upper endless belt 18 gradually moves, while rotating, to a position where the upper endless belt 18 is subjected to equal forces from the first and second guide members 72A and 72B, i.e. to the widthwise center position. In this way, the upper endless belt 18, when rotationally driven in the tension-released state, is positioned in the width direction by the first and second guide members 72A and 72B which are in the contact position.

The first guide member 72A and the second guide member 72B may be configured to contact the side edges 18c and 18d, respectively, of the upper endless belt 18 when the first and second guide members 72A and 72B are in the lower position. However, if the first and second guide members 72A and 72B push the upper endless belt 18 toward the widthwise center position in the lower position, which is relatively distant from the driven and driving rollers 24 and 26, the upper endless belt 18 may be distorted in the width direction and hence may fail to be sufficiently moved toward the widthwise center position. In this embodiment, as has been described above, the first guide member 72A and the second guide member 72B contact the side edges 18c and 18d, respectively, of the upper endless belt 18 in the upper position, which is relatively close to the driven roller 24 and the driving roller 26. Therefore, the upper endless belt 18 is unlikely to be distorted in the width direction. Accordingly, the widthwise positioning of the upper endless belt 18 can be performed even more efficiently.

With the double belt press apparatus 1 according to this embodiment, after the positioning of the upper endless belt 18 by the first guide member 72A and the second guide member 72B, even more accurate positioning of the upper endless belt 18 can be performed. To carry out such even more accurate positioning, the first guide member 72A and the second guide member 72B are moved to the lower position in the non-contact position as shown in FIG. 6(c). Next, the first guide member 72A and the second guide member 72B are moved to the contact position in the lower position. As a result of the first and second guide members 72A and 72B assuming the contact position, the heating-pressing member 52 and cooling-pressing member 54 of the upper pressing device 48 are each sandwiched between the first guide member 72A and the second guide member 72B and thus positioned relative to the upper endless belt 18 in the width direction and in the directions of rotation about the vertical axes R1 and R2 (FIG. 3). Next, the upper pressing device 48 descends from the standby position toward the lower pressing device 50 to reach a pressing position. At this time, the heating-pressing member 52 and the cooling-pressing member 54 descend while being guided by the first guide member 72A and the second guide member 72B. Therefore, when reaching the pressing position, the upper pressing device 48 is still kept positioned relative to the upper endless belt 18. The term “pressing position” used herein means a position at which the upper pressing device 48 supports the inner peripheral surface 18b of the upper endless belt 18 so that the gap D between the lower running portion 18a of the upper endless belt 18 and the upper running portion 20a of the lower endless belt 20 has a predetermined size appropriate for press-processing. It should be noted that the predetermined size of the gap D is changeable as desired according to a press-formed product to be manufactured. Accordingly, the pressing position of the upper pressing device 48 is also correspondingly changeable as desired. The pressing position for positioning the upper endless belt 18 as stated herein, however, need not necessarily be the same as the position at which actual press-processing is performed but may be set as a temporary position for positioning the upper endless belt 18.

After or at the same time as the upper pressing device 48 is displaced to the pressing position, the auxiliary rollers 28A and 28B are displaced to a lower position. It should be noted that the lower position of the auxiliary rollers 28A and 28B corresponds to the pressing position of the upper pressing device 48. Therefore, when the pressing position is changed, the lower position may be also changed automatically. At the same time as the forward auxiliary roller 28A is displaced to the lower position, the support plate 36 moves downward while slightly inclining to reach a position where the support plate 36 is in contact with or close to the upper endless belt 18. Subsequently, the driven roller 24 moves forward to an intermediate position shown in FIG. 6(d) to press the upper endless belt 18. Thus, the upper belt driving mechanism 22 assumes a tension application configuration to apply tension to the upper endless belt 18. More specifically, as a result of the auxiliary rollers 28A and 28B moving to the lower position and the driven roller 24 moving to the intermediate position, the inner peripheral surface of the upper endless belt 18 is strongly pressed by the rollers, resulting in a state where tension is applied to the upper endless belt 18. Subsequently, the first guide member 72A and the second guide member 72B move to the contact position. As shown in FIG. 6(d), in this state, the driving roller 26 is driven to drive the upper endless belt 18 to rotate. The double belt press apparatus 1 may include a position detecting sensor (not shown) for detecting the widthwise position of the upper endless belt 18. Any of various position detecting sensors are usable, e.g. an edge sensor optically detecting the position of one side edge 18c or the other side edge 18d of the upper endless belt 18, an optical camera detecting the position of one side edge 18c or the other side edge 18d from an image, or a mechanical switch detecting the position of one side edge 18c or the other side edge 18d by mechanically contacting the side edge 18c or 18d. If the position detecting sensor detects that the upper endless belt 18 has deviated in the width direction, the double belt press apparatus 1 drives the air cylinder 30A or 30B supporting the driven roller 24 so that greater force is applied to one side in the width direction of the upper endless belt 18 than the other side. Consequently, the rotating upper endless belt 18 gradually moves from the side to which greater force is applied toward the side to which less force is applied. For example, if the upper endless belt 18 deviates to the right side as seen in FIG. 2, the air pressure applied to the right air cylinder 30A is increased to apply greater force to the right side of the upper endless belt 18. By so doing, the upper endless belt 18 is induced to move toward the left side. Thus, the upper endless belt 18 can be positioned even more accurately. It should be noted that such even more accurate positioning operation is not necessarily needed when the above-described positioning by the first guide member 72A and the second guide member 72B provides sufficient accuracy. In addition, the double belt press apparatus 1 does not always need to have the function of performing the above-described accurate positioning operation.

Upon completion of the positioning by the first guide member 72A and second guide member 72B shown in FIG. 6(b) or the even more accurate positioning shown in FIG. 6(d), the double belt press apparatus 1 assumes a configuration shown in FIG. 7(a). The configuration shown in FIG. 7(a) is similar to the above-described configuration shown in FIG. 6(a); therefore, a detailed explanation thereof is omitted here. It should be noted that, in the state shown in FIG. 7(a), the positioning of the upper endless belt 18 has been completed.

To perform press-processing by the double belt press apparatus 1, first, as shown in FIG. 7(b), the first guide member 72A and the second guide member 72B assume the contact position in the lower position. At this time, the heating-pressing member 52 of the upper pressing device 48 is sandwiched between the first guide member 72A and the second guide member 72B and thus positioned relative to the upper endless belt 18 in the width direction and in the direction of rotation about the vertical axis R1 (FIG. 3). Similarly, the cooling-pressing member 54 is sandwiched between the first guide member 72A and the second guide member 72B and thus positioned relative to the upper endless belt 18 in the width direction and in the direction of rotation about the vertical axis R2 (FIG. 3). Subsequently, the driven roller 24 moves from the forward position to the intermediate position. In addition, the upper pressing device 48 moves to the pressing position, and the auxiliary rollers 28A and 28B each move to the lower position. It should be noted that the upper pressing device 48 descends from the standby position to the pressing position while being guided by the first guide member 72A and the second guide member 72B. Accordingly, when in the pressing position, the upper pressing device 48 is still kept positioned relative to the upper endless belt 18. In this way, the double belt press apparatus 1 assumes the configuration shown in FIGS. 1 to 3. In this state, as shown in FIG. 7(c), the upper endless belt 18 is driven by the driving roller 26 to rotate counterclockwise as seen in the figure, and the lower endless belt 20 is driven to rotate clockwise by the driving roller 42 (FIG. 1). By placing a workpiece on the lower endless belt 20, processing of the workpiece is performed as stated above.

When there is a relatively short idle time between the completion of a processing operation and the start of a subsequent processing operation, the first guide member 72A and the second guide member 72B may be temporarily retreated to the non-contact position with the upper and lower endless belts 18 and 20 kept rotationally driven. By so doing, it is possible to reduce the length of time that the first guide member 72A and the second guide member 72B are in sliding contact with the side edges 18c and 18d, respectively, of the upper endless belt 18 and hence possible to suppress the wear of the first and second guide members 72A and 72B.

Upon completion of a series of processing operations, the double belt press apparatus 1 according to this embodiment returns to the configuration shown in FIG. 7(d), which is the same as that shown in FIG. 7(a).

Despite the fact that the upper endless belt 18 has been positioned in the width direction by the process explained with reference to FIG. 6, the upper endless belt 18 may slightly deviate in the width direction or meander as the processing operation is continued. In the double belt press apparatus 1 according to this embodiment, the first guide member 72A and the second guide member 72B may be configured to be displaceable following the widthwise deviation or meandering of the upper endless belt 18. For example, if the upper endless belt 18 which has been accurately positioned as shown in FIG. 8(a) deviates to the right side as shown in FIG. 8(b), the first guide member 72A receives a strong force from the upper endless belt 18, to which tension is being applied. The force applied to the first guide member 72A is greater than the force of the air cylinders 88A and 88B for the horizontal direction, which are holding the first guide member 72A. Accordingly, the first guide member 72A moves to the right side by being pushed by the upper endless belt 18. On the other hand, the second guide member 72B is pressed against the side edge 18d by the air cylinders 88C and 88D for the horizontal direction. Therefore, when the upper endless belt 18 moves to the right side, the second guide member 72B is displaced rightward following the upper endless belt 18. Accordingly, the first guide member 72A and the second guide member 72B are displaced to the right side following the rightward displacement of the upper endless belt 18. Thus, the first and second guide members 72A and 72B are kept in contact with the upper endless belt 18. When the upper endless belt 18 meanders and runs diagonally as shown in FIG. 8(c), the air cylinder 88A extends, while the air cylinder 88B is withdrawn, so that the first guide member 72A tilts along the side edge 18c of the upper endless belt 18. It should be noted that the first guide member 72A is rotatably coupled to the air cylinders 88A and 88B by the first and second rotary couplers 76A and 76B, as has been stated above; therefore, the first guide member 72A can tilt as shown in the figure. Similarly, the second guide member 72B tilts along the side edge 18d of the upper endless belt 18. Thus, the first guide member 72A and the second guide member 72B can tilt following the meandering of the upper endless belt 18 and hence can be kept in contact with the upper endless belt 18.

It should be noted that FIG. 8 shows deviation and meandering exaggeratedly to facilitate understanding. The actual amount of deviation is extremely slight, normally not more than 1 mm, typically not more than 0.5 mm. Thus, in the double belt press apparatus 1, because the first and second guide members 72A and 72B are held movably in the horizontal direction, even if the upper endless belt 18 deviates in the width direction or meanders during a processing operation, the first and second guide members 72A and 72B can move in the horizontal plane following the upper endless belt 18. Accordingly, it is possible to suppress the formation of a gap between the side edges 18c and 18d of the upper endless belt 18, on the one hand, and, on the other, the first and second guide members 72A and 72B.

In addition, the heating-pressing member 52 and cooling-pressing member 54 of the upper pressing device 48 are held displaceably in the width direction and the direction of rotation about each of the vertical axes R1 and R2. Accordingly, the heating-pressing member 52 and the cooling-pressing member 54 move widthwise and rotate together with the first guide member 72A and the second guide member 72B, following the widthwise movement and rotation of the first and second guide members 72A and 72B. That is, the upper pressing device 48, together with the first and second guide members 72A and 72B, moves following the meandering and widthwise movement of the upper endless belt 18. Consequently, the following movement of the first and second guide members 72A and 72B is not obstructed by the upper pressing device 48. In addition, because there will be no misalignment between the upper pressing device 48 and the upper endless belt 18, a workpiece passing through the gap D can be pressed uniformly, thereby making it possible to stabilize the configuration of formed products thus manufactured.

Although some embodiments of the present invention have been explained above, the present invention is not limited by these embodiments. For example, the upper-side arrangement and the lower-side arrangement may be replaced with each other. That is, the first belt driving mechanism, which is transformable between the tension application configuration and the tension release configuration, may be arranged as the lower belt driving mechanism. In this case, the first pressing device, which is movable between the standby position and the pressing position, may be arranged as the lower pressing device. Furthermore, in this case, the first and second guide members may be arranged to move to the lower position (second position) downwardly away from the upper endless belt (second endless belt) when performing positioning of the lower endless belt (first endless belt) held by the lower belt driving mechanism, which is the first belt driving mechanism. In addition, the width of the upper endless belt may be greater than the width of the lower endless belt, thereby allowing the first and second guide members to contact the side edges, respectively, of the upper running portion (first opposing running portion) of the lower endless belt in a state where the first and second guide members are in contact with the outer peripheral surface of the lower running portion (second opposing running portion) of the upper endless belt.

Although in the foregoing embodiments air cylinders are used as actuators for moving various members such as the upper pressing device and the guide members, other various actuators are also usable, e.g. oil hydraulic cylinders, or electric motors. Furthermore, although in the foregoing embodiments the first and second guide members are pressed against the side edges, respectively, of the upper endless belt by the actuators for moving the first and second guide members in the horizontal direction, the arrangement may be such that the first and second guide members are pressed against the side edges of the upper endless belt by the urging force of an urging structure provided between each of the first and second guide members and the associated actuator, the urging structure comprising a resilient member, e.g. a spring or a rubber material. In addition, the first and second guide members need not necessarily be movable between the contact position and the non-contact position by actuators but may be arranged stationarily. The width of the lower endless belt may be the same as the width of the upper endless belt so that the first and second guide members contact the side edges of both the upper and lower endless belts.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A double belt press apparatus comprising:
a first belt unit having a first endless belt and a first belt driving mechanism configured to rotationally drive the first endless belt;
a second belt unit having a second endless belt disposed in alignment with the first endless belt in an up-down direction and a second belt driving mechanism configured to rotationally drive the second endless belt, the second endless belt having a width greater than a width of the first endless belt;
a pressing unit having a first pressing device and a second pressing device, the first pressing device supporting an inner peripheral surface of a first opposing running portion of the first endless belt, the second pressing device supporting an inner peripheral surface of a second opposing running portion of the second endless belt, the first opposing running portion and the second opposing running portion being located facing each other; and
a guide unit including a first guide member and a second guide member, the first guide member having a first guide surface extending along one side edge of the first opposing running portion to block at least a part of a gap between the first opposing running portion and the second opposing running portion from a side closer to the one side edge, the second guide member having a second guide surface extending along another side edge of the first opposing running portion to block at least a part of the gap from a side closer to the other side edge, the first guide member being disposed so that the first guide surface contacts the one side edge in a state where the first guide member contacts an outer peripheral surface of the second opposing running portion, the second guide member being disposed so that the second guide surface contacts the other side edge in a state where the second guide member contacts the outer peripheral surface of the second opposing running portion, wherein when the first and second endless belts are rotationally driven, the first guide surface slides against the one side edge and the second guide surface slides against the other side edge.

2. The double belt press apparatus of claim 1, wherein the first guide member is disposed so that the first guide surface is pressed against the one side edge, and the second guide member is disposed so that the second guide surface is pressed against the other side edge.

3. The double belt press apparatus of claim 2, wherein the first guide surface extends along one side edge of the first opposing running portion, and the second guide surface extends along the other side edge of the first opposing running portion; and
wherein the first and second guide members are held movably in a horizontal plane, so that when the first endless belt meanders or moves in a width direction, the first and second guide members move in the horizontal plane, following the first endless belt.

4. The double belt press apparatus of claim 3, wherein the guide unit further includes:
first and second horizontal actuators configured to move the first guide member between a contact position where the first guide surface is pressed against the one side edge and a non-contact position where the first guide surface is out of contact with the one side edge;
first and second rotary couplers attached to the first guide member at respective positions apart from each other in a running direction of the first opposing running portion of the first endless belt, the first rotary coupler coupling the first guide member to the first horizontal actuator so that the first guide member is rotatable relative to the first horizontal actuator about an axis perpendicular to the first opposing running portion, the second rotary coupler coupling the first guide member to the second horizontal actuator so that the first guide member is rotatable relative to the second horizontal actuator about an axis perpendicular to the first opposing running portion;
third and fourth horizontal actuators configured to move the second guide member between a contact position where the second guide surface is pressed against the other side edge and a non-contact position where the second guide surface is out of contact with the other side edge; and
third and fourth rotary couplers attached to the second guide member at respective positions apart from each other in the running direction, the third rotary coupler coupling the second guide member to the third horizontal actuator so that the second guide member is rotatable relative to the third horizontal actuator about an axis perpendicular to the first opposing running portion, the fourth rotary coupler coupling the second guide member to the fourth horizontal actuator so that the second guide member is rotatable relative to the fourth horizontal actuator about an axis perpendicular to the first opposing running portion.

5. The double belt press apparatus of claim 3, wherein the first pressing device is disposed displaceably in the width direction of the first endless belt and in a direction of rotation about an axis perpendicular to the first opposing running portion of the first endless belt, the first pressing device being held between the first and second guide members so as to move following the first endless belt, together with the first and second guide members.

6. The double belt press apparatus of claim 3, wherein the guide unit further includes a horizontally moving mechanism configured to move the first and second guide members between a contact position where the first and second guide surfaces are pressed against the side edges, respectively, and a non-contact position where the first and second guide surfaces are out of contact with the side edges, respectively;
the first pressing device being disposed displaceably in the width direction of the first endless belt and in a direction of rotation about an axis perpendicular to the first opposing running portion of the first endless belt and configured to be movable between a pressing position where the first pressing device supports an inner peripheral surface of the first endless belt so that the gap between the first opposing running portion of the first endless belt and the second opposing running portion of the second endless belt has a predetermined size for press-processing and a standby position more away from the second pressing device than the pressing position;
wherein when the first and second guide members are in the contact position in a state where the first pressing device is in the standby position, the first pressing device is held between the first and second guide members and thus positioned relative to the first and second guide members, so that the first pressing device moves from the standby position to the pressing position while being guided by the first and second guide members.

7. The double belt press apparatus of claim 1, wherein the first endless belt is an upper endless belt, and the second endless belt is a lower endless belt disposed beneath the upper endless belt.

8. The double belt press apparatus of claim 1, wherein the first belt driving mechanism is transformable between a tension application configuration where tension is applied to the first endless belt and a tension release configuration where the first endless belt is released from tension, so that the first endless belt is positioned in a width direction by rotationally driving the first endless belt in a state where the first belt driving mechanism is in the tension release configuration and the first and second guide members contact the side edges, respectively, of the first endless belt.

9. The double belt press apparatus of claim 8, wherein the first belt driving mechanism includes a first roller and a second roller which are disposed at respective positions apart from each other in a horizontal direction to support the inner peripheral surface of the first endless belt;
the first belt driving mechanism being transformed from the tension application configuration to the tension release configuration in response to displacement of at least one of the first and second rollers toward an inner side of the first endless belt;
the first and second guide members being movable in the up-down direction between a first position where the first and second guide members contact the second endless belt and a second position where the first and second guide members are away from the second endless belt toward the first roller and the second roller;
wherein the first endless belt is positioned in the width direction by rotationally driving the first endless belt in a state where the first belt driving mechanism is in the tension release configuration and the first and second guide members are in the second position and in contact with the side edges, respectively, of the first endless belt.

10. A double belt press apparatus comprising:
a first belt unit having a first endless belt and a first belt driving mechanism configured to rotationally drive the first endless belt;
a second belt unit having a second endless belt disposed in alignment with the first endless belt in an up-down direction, and a second belt driving mechanism configured to rotationally drive the second endless belt;
a pressing unit having a first pressing device and a second pressing device, the first pressing device supporting an inner peripheral surface of a first opposing running portion of the first endless belt, the second pressing device supporting an inner peripheral surface of a second opposing running portion of the second endless belt, the first opposing running portion and the second opposing running portion being located facing each other; and
a guide unit including a first guide member and a second guide member, the first guide member having a first guide surface extending along one side edge of at least one running portion of the first opposing running portion and the second opposing running portion to block at least a part of a gap between the first opposing running portion and the second opposing running portion from a side closer to the one side edge, the second guide member having a second guide surface extending along another side edge of the at least one running portion to block at least a part of the gap from a side closer to the other side edge, the first guide member being disposed so that the first guide surface contacts the one side edge, the second guide member being disposed so that the second guide surface contacts the other side edge, so that when the first and second endless belts are rotationally driven, the first guide surface slides against the one side edge and the second guide surface slides against the other side edge;
wherein the first belt driving mechanism is configured to transform between a tension application configuration where tension is applied to the first endless belt and a tension release configuration where the first endless belt is released from tension, so that the first endless belt is positioned in a width direction by rotationally driving the first endless belt in a state where the first belt driving mechanism is in the tension release configuration and the first and second guide members contact the side edges, respectively, of the first endless belt.
